(19) United States
(12) Patent Application Publication
(10) Pub. No.: US 2025/0193742 A1
(43) Pub. Date: Jun. 12, 2025

(54) SYSTEMS AND METHODS FOR SMART DYNAMIC FREQUENCY SELECTION

(71) Applicant: PLUME DESIGN, INC., Palo Alto, CA (US)

(72) Inventors: Badri Srinivasan SAMPATHKUMAR, Fremont, CA (US); Stephen H. GRAU, Pleasanton, CA (US)

(21) Appl. No.: 18/531,777

(22) Filed: Dec. 7, 2023

(51) Int. Cl. H04W 28/24; H04W 28/08; H04W 72/0453

(52) U.S. Cl. CPC H04W 28/24; H04W 28/0967; H04W 72/0453

(57) ABSTRACT

Disclosed are systems and methods that provide a computerized network management framework that provides novel network optimization for WiFi networks. The framework provides operations that can operate in a “device aware” DFS mode, which is configured to enable the implementation of additional DFS channels. The disclosed device aware DFS mode can enable, cause and/or effectuate the spread of Wi-Fi communications over more channels, thereby reducing interference and congestion, while improving the quality of experience (QoE) for users with devices connected to such networks. The computerized implementations for deploying DFS mode within a WiFi network at a location can leverage the extensive use of DFS channels where applicable, while preserving the non-DFS tunings at locations with critical devices that do not support DFS capabilities.

### FIELD OF THE DISCLOSURE

The present disclosure is generally related to network management, and more particularly, to a decision intelligence (DI)-based computerized framework for performing network-based, smart dynamic frequency selection (DFS).

### SUMMARY OF THE DISCLOSURE

Disclosed are computerized systems and methods for a network management framework that provides novel network optimization for Wireless Fidelity (WiFi) networks, such as WiFi Mesh networks. As discussed herein, the disclosed framework provides novel operations that can operate in a “device aware” DFS mode, which is configured to enable the implementation of additional 5 GHz channels (DFS channels). According to some embodiments, as evidenced from the instant disclosure, the disclosed device aware DFS mode can enable, cause and/or effectuate the spread Wi-Fi communications over more channels, thereby reducing interference and congestion, while improving the quality of experience (QoE) for users with devices connected to such networks.

According to some embodiments, a method is disclosed for performing network-based, smart DFS. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for performing network-based, smart DFS.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/a/g/n/ac/ax/be, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures.

By way of background, while using the DFS channels is highly advantageous, these channels are not currently being used because certain devices, as certain devices do not support operations on DFS channels (e.g., certain versions of Roku™ and Amazon Fire® TV streaming devices, for example). Currently, such devices are forced on to the more congested (and, in some instances, lower bandwidth) 2.4 GHz band when 5 GHz radios are tuned to DFS channels. This, among other drawbacks, can cause quality of service (QOS) problems.

Accordingly, the disclosed device aware mode(s) (or optimization) disclosed herein can enable DFS channels to be used in locations that do not have any of these devices, while not using DFS channels in locations where these non-DFS-capable devices are present. As a result, locations that do not have these devices (e.g., non-DFS-capable devices) can take advantage of the extra channels, while locations that do have these devices will not be impacted.

According to some embodiments, by way of a non-limiting example, in implementations when there are multiple access points in a Mesh network and each access point has multiple radios in the 5 GHz band, then the disclosed framework can operate to enable the network to be configured with a fair distribution (or ratio) of DFS and non-DFS channels between the 5 GHz radios (e.g., the distribution can be based on factors including, but not limited to, device connectivity, network and/or band bandwidth, network activity, number of devices on particular bands, predetermined settings, and the like). Accordingly, such configuration of the network can accommodate the types of client devices that are capable of operating in the DFS channels and those that are incapable of operating in the DFS channels. According to some embodiments, in a non-limiting example of a degenerate case, if there is only one 5 GHz radio on each access point to be managed, the disclosed framework can deterministically select between a non-DFS and DFS channel based on the presence/absence of non-DFS-capable devices at that location.

Accordingly, as discussed herein, DFS capabilities enabled by the disclosed framework can implement protocols that i) do not use DFS channels and ii) ensuring a portion, but not all, radios are activated, which can be specific to DFS and non-DFS devices.

Thus, as discussed in more detail below, the disclosed systems and methods provide computerized implementations for deploying DFS mode within a WiFi network at a location (e.g., home, office, and the like), thereby making extensive use of DFS channels where applicable, while preserving the non-DFS tunings at locations with critical devices that do not support DFS capabilities.

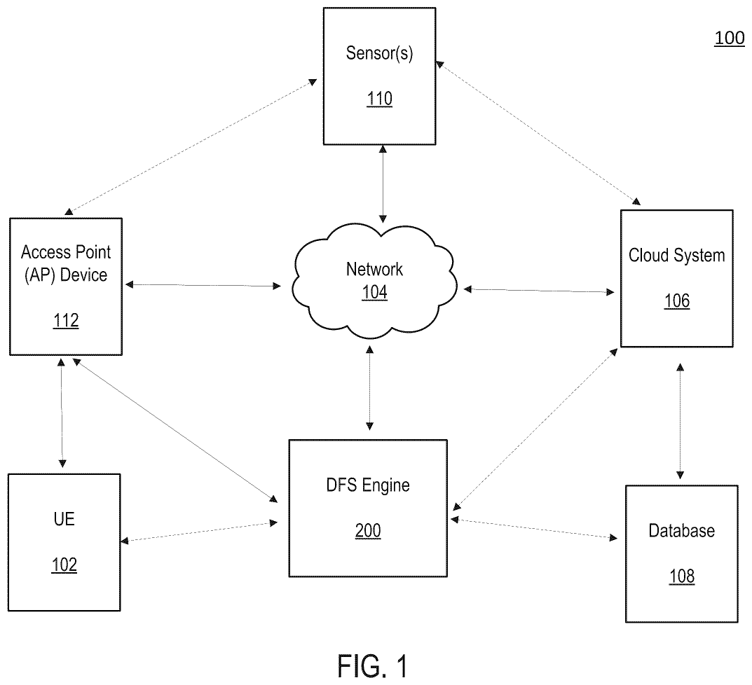

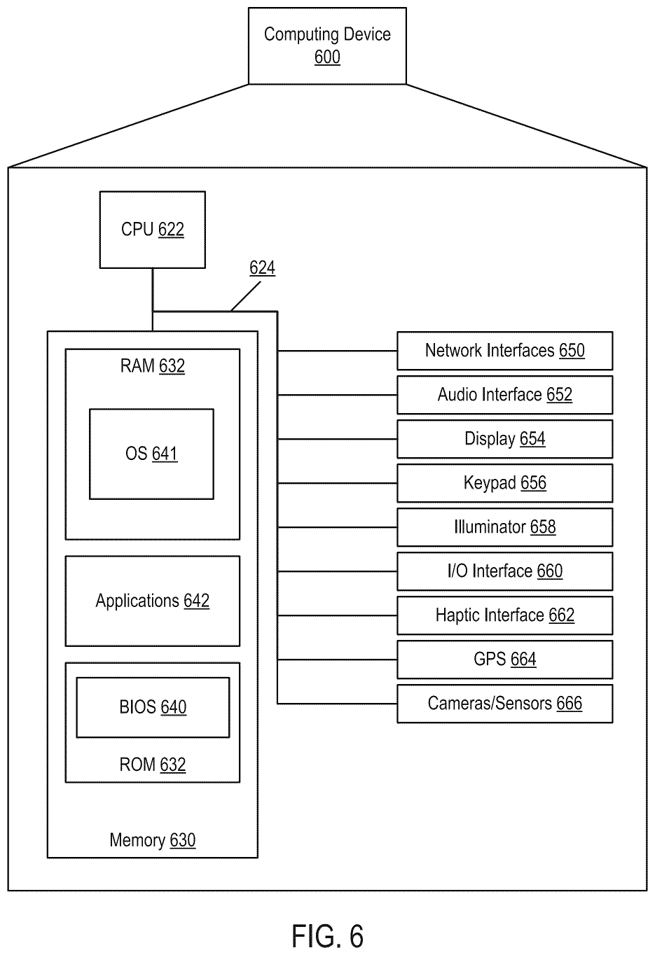

With reference to FIG. 1, system 100 is depicted which includes user equipment (UE) 102 (e.g., a client device, as mentioned above and discussed below in relation to FIG. 6), AP device 112, network 104, cloud system 106, database 108, sensors 110 and dynamic frequency selection (DFS) engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, IoT device, wearable device, autonomous machine, smart television, media streaming device, game console, and any other device equipped with a cellular or wireless or wired transceiver.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

According to some embodiments, sensors 110 can correspond to any type of device, component and/or sensor associated with a location of system 100 (referred to, collectively, as “sensors”). In some embodiments, the sensors 110 can be any type of device that is capable of sensing and capturing data/metadata related to activity of the location. For example, the sensors 110 can include, but not be limited to, cameras, motion detectors, door and window contacts, heat and smoke detectors, passive infrared (PIR) sensors, time-of-flight (ToF) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. For example, the sensors 110 can include the sensors on UE 102 (e.g., smart phone) and/or peripheral device (e.g., a paired smart ring). In some embodiments, sensors 110 can be associated with any device connected and/or operating on cloud system 106 (e.g., a cloud-based device, such as a server that collects information related to the location, for example).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider (e.g., Plume Design®), which has associated network resources hosted on the internet or private network (e.g., network 104), which enables (via engine 200) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, sensors 110, and the services and applications provided by cloud system 106 and/or DFS engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

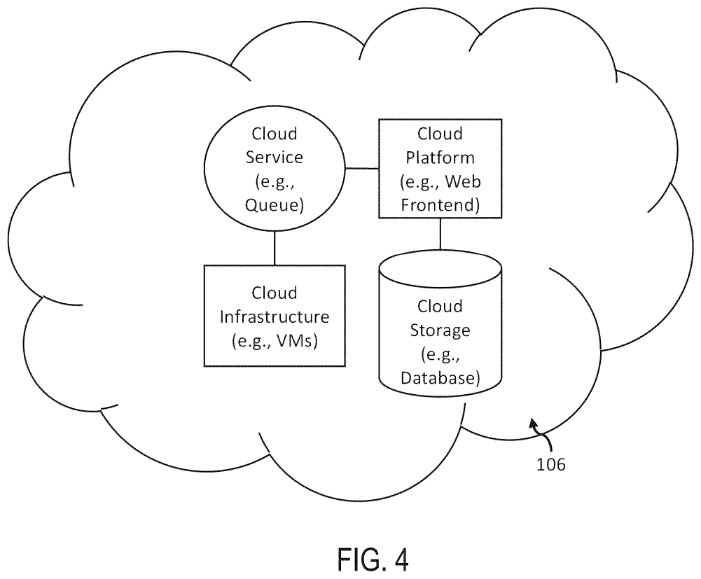

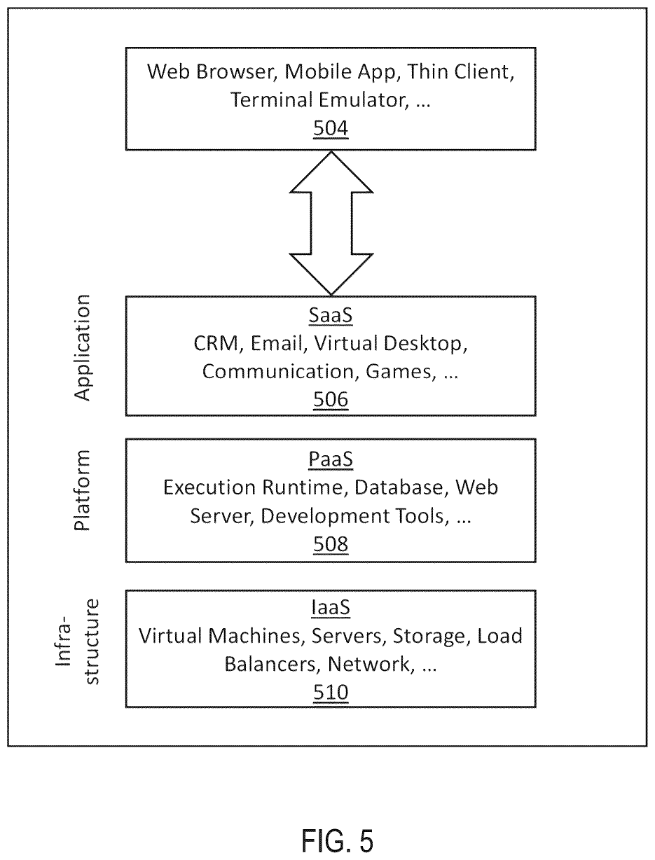

Turning to FIGS. 4 and 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIGS. 4 and 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, structured query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

DFS engine 200, as discussed above and further below in more detail, can include components for the disclosed functionality. According to some embodiments, DFS engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

According to some embodiments, as discussed in more detail below, DFS engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, DFS engine 200 may function as an application provided by cloud system 106. In some embodiments, engine 200 may function as an application installed on a server(s), network location and/or other type of network resource associated with system 106. In some embodiments, engine 200 may function as an application installed and/or executing on AP device 112 and/or UE 102 (and/or sensors 110). In some embodiments, such application may be a web-based application accessed by AP device 112 and/or UE 102, and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on AP device 112, UE 102 and/or sensors 110.

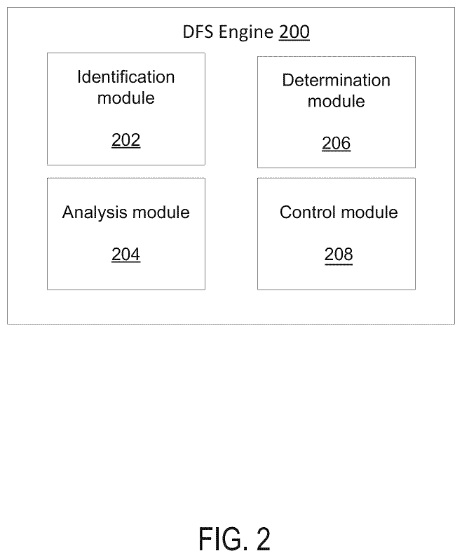

As illustrated in FIG. 2, according to some embodiments, DFS engine 200 includes identification module 202, analysis module 204, determination module 206 and control module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

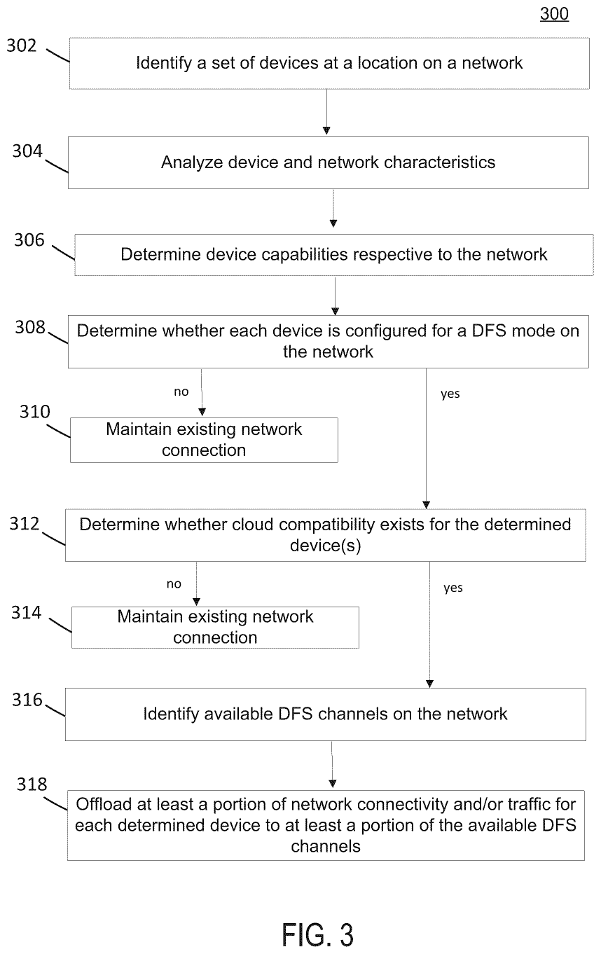

Turning to FIG. 3, Process 300 provides non-limiting example embodiments for the disclosed network management framework. According to some embodiments, Process 300 provides the executable steps that enables the adaptive DFS management of the network and its associated network/application/device management/control.

According to some embodiments, as discussed herein, enabling DFS channels can open more DFS channels (e.g., 5 GHz channels) on the network, which can be either or both on the fronthaul or backhaul between UEs and/or APs. This, therefore, can improve the QoE by reducing interference and congestion, as discussed herein.

According to some embodiments, Steps 302 and 316 of Process 300 can be performed by identification module 202 of DFS engine 200; Step 304 can be performed by analysis module 204; Steps 306, 308 and 312 can be performed by determination module 206; and Steps 310, 314 and 318 can be performed by control module 208.

According to some embodiments, Process 300 begins with Step 302 where engine 200 can identify a set of devices associated with a location. In some embodiments, the set of devices can be devices that are connected to a network associated with the location, and/or connect to the network at least a threshold amount of times per a threshold amount of time (e.g., connects to the network at least 20 times per month, thereby indicating they live at the location, for example). In some embodiments, the devices can have associated, and/or installed therewith, applications that have been downloaded, installed and/or web-based applications that execute on such devices and leverage the network at the location to perform application-based processing and/or network resource management implementation.

Any type of application that can execute on a UE 102 can be identified in Step 302 (e.g., Netflix®, YouTube®, Amazon Fire TV®, Zoom®, and the like). For example, an application can be any type of augmented reality or virtual reality (AR/VR) application, and/or an associated AR/VR device executing such application (e.g., Apple Vision Pro headset, for example).

In some embodiments, such identified devices can include any type of device, which as discussed above, can include UE 102, AP 112 and/or sensor 110, as discussed supra. Thus, as discussed below, the collection of data from/via such devices can correspond to network activity, motion and/or presence activity, and the like, or some combination thereof.

According to some embodiments, a location can correspond to, but is not limited to, a home, office, building, multi-dwelling unit (e.g., apartment complexes, for example) and/or any other type of physical location that can be configured to host and/or provide network connectivity to devices in/around a geographic and/or physical area (e.g., a cabin on a ship, for example). Accordingly, in some embodiments, the network, as discussed above, can be any type of communication network (e.g., a location-based or associated network such as Wi-Fi network, for example) that can enable devices to automatically connect upon being within range of the location and/or access point devices providing the network at/around the location.

Accordingly, in some embodiments, Step 302 can further involve, upon identification of the set of devices, an identification of the applications that are executing on the network from each device. According to some embodiments, identification of an application may be based on a criteria, such that, but not limited to, a certain amount of network traffic may be required to be associated with the application per a threshold time period for the application to be specifically identified. For example, if a user only uses an application once every month, and the application is simply to check stock prices, this minimal data usage may not be adequate to consider as part of the “regular” operations on the network. However, if a user, via their smart TV, streams movies at least 5 days a week, this would be considered a substantial amount of activity, therefore the applications executing on the TV to enable the streaming (e.g., Netflix®, Hulu®, for example) can be identified.

In some embodiments, Step 302 can further involve the identification of information, which can include, but is not limited to, a type of application, identity of application, version of application, subscription level associated with application, account(s) associated with application, device hosting the application, frequency of usage of application, MAC address or IP address of the device, the like, or some combination thereof. The information identified can further include, but is not limited to, device type, device identifiers, user identifiers and device capabilities (e.g., DFS enabled or non-DFS enabled), and the like.

Accordingly, the information generated, communicated, shared, received, downloaded by a device and the applications executing thereon can be referred to as “device information.”

In Step 304, engine 200 can operate to collect and analyze the device information, which can also include the network characteristics for which each device is connected. For example, the network characteristics can include, but are not limited to, for each device and/or as a whole of the network, signal strength, throughput, interference, congestion, bandwidth, upload/download speeds, number of devices connected, number of devices communicating a threshold amount of data, which channels are being utilized, which devices are using certain channels, and the like.

Thus, in Step 304, engine 200 can analyze the device and network information, which can be collected continuously and/or according to a predetermined period of time or interval. In some embodiments, the data may be collected based on detected events. In some embodiments, type and/or quantity of data may be directly tied to the type of application/device/network channel. For example, a device may only generate data for collection upon it being engaged in or causing network traffic over a certain channel (e.g., 2.4 GHz). In some embodiments, the collected data in Step 304 can be stored in database 108 in association with an ID of a user, application, device, location and/or an associated account of any of the preceding user, application, device and/or location.

Accordingly, the analysis performed by engine 200 in Step 304 can be performed by any type of known or to be known computational analysis technique, algorithm, mechanism or technology to analyze the collected data related to the devices and/or network.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the collected data, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 306, based on the analysis from Step 304, engine 200 can determine device capabilities respective to the network. That is, as discussed above, engine 200 can, for each identified device (from Step 302): i) which channel and/or type of network connection is currently being implemented, ii) type of network activity and/or metrics associated therewith (e.g., throughput, for example), and iii) whether the device can (e.g., is capable to) leverage a DFS channel. In some embodiments, device capabilities can include, but are not limited to, a device type, device model, device brand, device operating system (OS), applications installed on the device, service provider associated with the device, and the like, or some combination thereof.

In some embodiments, such determination can identify and account for such factors for each device, and perform an AI/ML based determination whether DFS channels should be used, are available and/or can be used for the devices on the network, as a whole. Indeed, in some embodiments, such determination, as discussed herein, can determine whether the device is DFS capable (or non-capable), and/or may be adversely impacted by being pushed/switched to a particular band (e.g., 2.4 GHz, for example).

In Step 308, engine 200 can determine whether each device is configured for a DFS mode operation and/or whether the DFS mode operation is viable for the network. In some embodiments, the determination in Step 308 can be dependent on and/or utilize as a factor of whether other devices on the network are DFS-capable. For example, if a device is configured for DFS modes, yet other devices are not, then, in some embodiments, Step 308 may cause the network connection for each of the connected devices to avoid DFS usage.

In some embodiments, DFS mode determinations may be based on a “by-device” basis, in that if a device is DFS capable, and there is the availability on a DFS channel on the network, then that device can be switch to a DFS channel, which can reduce congestion and/or interference with other devices network activities on non-DFS channels (e.g., 2.4 GHz).

Accordingly, processing can proceed from Step 308 to Step 310 when non-DFS channels are to be maintained for a device, a portion of the devices or all the devices (from Step 302). In some embodiments, when a DFS mode is to be enabled, via the determination in Step 308, engine 200 can proceed from Step 308 to Step 312.

In Step 312, engine 200 can perform a determination as to whether cloud (e.g., cloud system 106, discussed supra) currently exists for the determined device. Such compatibility can be based on, but not limited to, an account for the device, user and/or applications executing on/via the device, the location's network, an account for the location's network, and the like, or some combination thereof.

According, the cloud compatibility determination for DFS channel selection and/or activation in Step 312 can correspond to and/or be based on WiFi network's hardware and software, particularly APs and controllers, are designed to work seamlessly with DFS channels in the cloud environment. Such determination can be based on, but not limited to, DFS channel support, dynamic configuration, centralized management, regulatory compliance, real-time monitoring and scalability.

In some embodiments, with regard to DFS channel support, cloud-compatible WiFi systems can allow for the configuration and management of DFS channels. In some embodiments, these channels are often monitored for radar signals, and the network can intelligently switch to non-DFS channels when radar activity is detected to comply with regulations, as discussed above.

In some embodiments, with regard to dynamic configuration, a cloud-based system can provide the ability to dynamically configure DFS channel usage based on real-time data and regulations. In some embodiments, the cloud system and/or engine 200 can automatically select non-interfering channels when needed.

In some embodiments, with regard to centralized management, cloud compatibility implies that DFS channel management can be performed centrally through a web-based interface or cloud-based management platform (e.g., via engine 200). Thus, as discussed herein, this enables network components and/or administrators to make changes and monitor DFS channels across multiple APs and/or devices for a location.

In some embodiments, with regard to regulatory compliance, cloud-compatible WiFi systems can have the intelligence to adhere to regional regulatory requirements for DFS channels.

In some embodiments, real-time monitoring for cloud systems often include real-time monitoring and reporting capabilities, which help in tracking DFS channel usage, detecting radar interference, and optimizing channel selection based on current conditions (e.g., as discussed above in at least Steps 302-306).

And, in some embodiments, a cloud system can be required to implement a threshold amount of scalability, which can allow users (and/or entities) to expand their WiFi network capabilities at a network while maintaining compatibility with DFS channels.

Thus, in Step 312, engine 200 can leverage cloud compatibility determinations for DFS channels in a WiFi network to ensure that the network can efficiently and dynamically manage DFS channels while complying with regional regulations and allowing centralized control and monitoring through a cloud-based platform. Thus, this, among other benefits, can help maintain reliable and interference-free WiFi service in environments where DFS channels are required.

According to some embodiments, when cloud compatibility does not exist for a DFS device and/or cannot be maintained, for at least one of the above factors listed in Step 312, engine 200 can perform Step 314, where the existing non-DFS channel can be maintained and/or toggled back to (if the DFS channel was activated).

Alternatively, in some embodiments, when cloud compatibility does exist and can be maintained (e.g., at least for a threshold period of time and/or for a type of network event per device and/or for the network at the location), engine 200 can proceed to Step 316. In Step 316, engine 200 can scan the network, including the available tunings, channels and/or radios of the AP devices operating therein/thereon, and identify available the DFS channels on the network.

And, in Step 318, engine 200 can offload the identified devices (from Steps 308 and 312) to such DFS channels. Accordingly, in some embodiments, engine 200 can offload at least a portion of network connectivity and/or traffic for each determined device (from Steps 308 and 312) to at least a portion of available DFS channels. In some embodiments, which can be dependent on the number of available DFS channels (from Step 316), each device can be switched to their own DFS channel and/or share a DFS channel.

Accordingly, in some embodiments, engine 200 can, via the steps of Process 300 discussed supra, enable, cause and/or effectuate the spread Wi-Fi communications over more channels, thereby reducing interference and congestion, while improving the QoE for users with devices connected to such networks. The computerized implementations for deploying DFS mode within a WiFi network at a location can leverage the extensive use of DFS channels where applicable, while preserving the non-DFS tunings at locations with critical devices that do not support DFS capabilities.

According to some embodiments, in line with the discussion above respective to FIG. 3, currently in Europe, where there are very few non-DFS channels (e.g., only one 80 MHz non-DFS channel), use of DFS channels may be the default, preferring forcing non-DFS-capable devices onto the 2.4 GHz band, thereby severely impacting the service for DFS-capable devices. In Europe such settings can be automatically overridden to be in a mode of “DFS enabled,” whereby a notification of change (NOC) instruction can be communicated via engine 200 to AP device 112, UE 102 and/or sensor 110 to activate the DFS mode discussed herein. Thus, rather than operating as a “DFS extension”, devices can operate in DFS mode, according to the operational functionality discussed above and provided via Process 300, discussed supra. Indeed, the disclosed DFS settings can be utilized to override particular settings in certain jurisdictions, where applicable and in compliance with regulations, to enable the disclosed functionality.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:

Aspect 1. A method comprising:
identifying a connection between a device and a network at a location;
analyzing the connection, and determining, based on the analysis, device and network characteristics, the device characteristics indicating networking capabilities of the device, the network characteristics indicating a current network configuration of the device on the network;
determining, based on the determined device and network characteristics, whether to engage a dynamic frequency selector (DFS) mode for the network, the DFS mode enabling the device access to a DFS channel associated with the network; and
controlling the connection between the device and the network based on the DFS mode determination, the controlled connection comprising functionality for managing which available network channels the device utilizes to communicate over the network.
   Aspect 2. The method of aspect 1, further comprising:
determining to engage DFS mode, the determination based on the device characteristics indicating the device is compatible with the DFS channel and the network characteristics indicating the DFS channel is available.
   Aspect 3. The method of aspect 2, wherein the control of the connection comprises activating the DFS mode on the network for the device and offloading the device to the DFS channel.
   Aspect 4. The method of aspect 1, wherein the device is one of a set of devices at the location, each of the set of devices being connected to the network.
   Aspect 5. The method of aspect 4, wherein the DFS mode determination for the device is based on device and network characteristics of each other device in the set of devices.
   Aspect 6. The method of aspect 5, wherein the DFS mode is not engaged for the device when at least one of the other devices in the set of devices is not DFS compatible.
   Aspect 7. The method of aspect 1, further comprising:
analyzing information related to cloud compatibility for the device; and
determining whether cloud compatibility exists on the network, via an associated cloud system, for the device.
   Aspect 8. The method of aspect 7, further comprising:
dismissing DFS capabilities for the device based on a determination that the cloud compatibility does not exist.
   Aspect 9. The method of aspect 7, wherein offloading of the device to the DFS channel is further based on the cloud compatibility determination.
   Aspect 10. The method of aspect 1, further comprising:
determining a set of 5 GHz radios associated with an access point of a network; and
determining, based on the device and network characteristics, a distribution between DFS and non-DFS modes, wherein
   when the set of 5 GHz radios includes a single radio, selecting the DFS mode or
non-DFS mode based on the device and network characteristics of the single radio, and when the set of 5 GHz radios includes a plurality of radios, selecting the DFS mode or non-DFS mode for plurality of radios based on the distribution.
   Aspect 11. The method of aspect 1, wherein the network is a Wireless Fidelity (WiFi) Mesh network.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying a connection between a device and a network at a location;
analyzing the connection, and determining, based on the analysis, device and network characteristics, the device characteristics indicating networking capabilities of the device, the network characteristics indicating a current network configuration of the device on the network;
determining, based on the determined device and network characteristics, whether to engage a dynamic frequency selector (DFS) mode for the network, the DFS mode enabling the device access to a DFS channel associated with the network; and
controlling the connection between the device and the network based on the DFS mode determination, the controlled connection comprising functionality for managing which available network channels the device utilizes to communicate over the network.

2. The method of claim 1, further comprising:
determining to engage DFS mode, the determination based on the device characteristics indicating the device is compatible with the DFS channel and the network characteristics indicating the DFS channel is available.

3. The method of claim 2, wherein the control of the connection comprises activating the DFS mode on the network for the device and offloading the device to the DFS channel.

4. The method of claim 1, wherein the device is one of a set of devices at the location, each of the set of devices being connected to the network.

5. The method of claim 4, wherein the DFS mode determination for the device is based on device and network characteristics of each other device in the set of devices.

6. The method of claim 5, wherein the DFS mode is not engaged for the device when at least one of the other devices in the set of devices is not DFS compatible.

7. The method of claim 1, further comprising:
analyzing information related to cloud compatibility for the device; and
determining whether cloud compatibility exists on the network, via an associated cloud system, for the device.

8. The method of claim 7, further comprising:
dismissing DFS capabilities for the device based on a determination that the cloud compatibility does not exist.

9. The method of claim 7, wherein offloading of the device to the DFS channel is further based on the cloud compatibility determination.

10. The method of claim 1, further comprising:
determining a set of 5 GHz radios associated with an access point of a network; and
determining, based on the device and network characteristics, a distribution between DFS and non-DFS modes, wherein
when the set of 5 GHz radios includes a single radio, selecting the DFS mode or non-DFS mode based on the device and network characteristics of the single radio, and
when the set of 5 GHz radios includes a plurality of radios, selecting the DFS mode or non-DFS mode for plurality of radios based on the distribution.

11. A system comprising:
a processor configured to:
identify a connection between a device and a network at a location;
analyze the connection, and determine, based on the analysis, device and network characteristics, the device characteristics indicating networking capabilities of the device, the network characteristics indicating a current network configuration of the device on the network;
determine, based on the determined device and network characteristics, whether to engage a dynamic frequency selector (DFS) mode for the network, the DFS mode enabling the device access to a DFS channel associated with the network; and
control the connection between the device and the network based on the DFS mode determination, the controlled connection comprising functionality for managing which available network channels the device utilizes to communicate over the network.

12. The system of claim 11, wherein the processor is further configured to:
determine to engage DFS mode, the determination based on the device characteristics indicating the device is compatible with the DFS channel and the network characteristics indicating the DFS channel is available,
wherein the control of the connection comprises activating the DFS mode on the network for the device and offloading the device to the DFS channel.

13. The system of claim 11, wherein the device is one of a set of devices at the location, each of the set of devices being connected to the network, and
wherein the DFS mode determination for the device is based on device and network characteristics of each other device in the set of devices.

14. The system of claim 13, wherein the DFS mode is not engaged for the device when at least one of the other devices in the set of devices is not DFS compatible.

15. The system of claim 11, wherein the processor is further configured to:
analyze information related to cloud compatibility for the device; and
determine whether cloud compatibility exists on the network, via an associated cloud system, for the device,
wherein control of the network connection for the device is further based on the cloud compatibility determination.

16. A non-transitory computer-readable storage medium tangibly encoded with computer-executable instructions that when executed by a processor, perform a method comprising:
identifying a connection between a device and a network at a location;
analyzing the connection, and determining, based on the analysis, device and network characteristics, the device characteristics indicating networking capabilities of the device, the network characteristics indicating a current network configuration of the device on the network;
determining, based on the determined device and network characteristics, whether to engage a dynamic frequency selector (DFS) mode for the network, the DFS mode enabling the device access to a DFS channel associated with the network; and
controlling the connection between the device and the network based on the DFS mode determination, the controlled connection comprising functionality for managing which available network channels the device utilizes to communicate over the network.

17. The non-transitory computer-readable storage medium of claim 16, further comprising:
determining to engage DFS mode, the determination based on the device characteristics indicating the device is compatible with the DFS channel and the network characteristics indicating the DFS channel is available,
wherein the control of the connection comprises activating the DFS mode on the network for the device and offloading the device to the DFS channel.

18. The non-transitory computer-readable storage medium of claim 16, wherein the device is one of a set of devices at the location, each of the set of devices being connected to the network, and
wherein the DFS mode determination for the device is based on device and network characteristics of each other device in the set of devices.

19. The non-transitory computer-readable storage medium of claim 18, wherein the DFS mode is not engaged for the device when at least one of the other devices in the set of devices is not DFS compatible.

20. The non-transitory computer-readable storage medium of claim 16, further comprising:
analyzing information related to cloud compatibility for the device; and
determining whether cloud compatibility exists on the network, via an associated cloud system, for the device,
wherein control of the network connection for the device is further based on the cloud compatibility determination.
